(19) United States
(12) Patent Application Publication
(10) Pub. No.: US 2025/0086853 A1
(43) Pub. Date: Mar. 13, 2025

(54) SYSTEMS, METHODS, AND INTERFACES FOR VIEWING AND MODIFYING SUB-COMPONENTS OF A COATING

(71) Applicant: PPG Industries Ohio, Inc., Cleveland, OH (US)

(72) Inventors: Bilge Carritte, Avon Lake, OH (US); Natalie M. Scott, Cleveland, OH (US); Alison M. Norris, Gibsonia, PA (US)

(73) Assignee: PPG Industries Ohio, Inc., Cleveland, OH (US)

(21) Appl. No.: 18/580,304

(22) PCT Filed: Jul. 12, 2022
(86) PCT No.: PCT/US2022/073624

§ 371 Date: Jan. 18, 2024

Related U.S. Application Data
(60) Provisional application No. 63/223,623, filed on Jul. 20, 2021.

(51) Int. Cl. G06T 11/00; G01J 3/02; G01J 3/46; G06F 3/0482; G06F 3/04845; G06T 11/60

(52) U.S. Cl. CPC G06T 11/001; G01J 3/0264; G01J 3/0272; G01J 3/463; G06F 3/0482; G06F 3/04845; G06T 11/60

(57) ABSTRACT

A computer-implemented method can include providing via a digital display a graphical user interface including one or more selectable elements for retrieving spectrophotometer data measured from a target asset. The method also includes receiving spectrophotometer data from an end user of the graphical user interface, and retrieving from a database a plurality of closest match colors corresponding to the spectrophotometer data. In addition, the method can include displaying a plurality of selectable color tiles corresponding to the retrieved closest match colors, and further displaying an image for each of one or more selectable sub-component options corresponding to one or more alternate formulas for at least one of the selectable color tiles. The method further includes displaying both the adjusted formula and related sub-components corresponding to the user modifications, as well as options to select the color as a coating for eventual application.

### BACKGROUND OF THE INVENTION

### 1. Technical Field

The present invention relates to devices, computer-implemented methods, and systems for modifying coating compositions through a graphical user interface.

### 2. Background and Relevant Art

Modern coatings provide several important functions in industry and society. Coatings can protect a coated material from corrosion, such as rust. Coatings can also provide an aesthetic function by providing a particular color and/or texture to an object. For example, most assets such as automobiles are coated using paints and various other coatings in order to protect the metal body of the automobile from the elements and also to provide aesthetic visual effects.

In view of the wide-ranging uses for different coatings, it is often necessary to identify a target coating composition. For instance, it might be necessary to identify a target coating composition on an asset that has sustained damage (e.g., has been in an accident). However, due to the nature of complex mixtures within coatings, it is sometimes difficult to formulate, identify, and/or search for acceptable matching formulations and/or pigmentations. Even in the case where a suitable match can be identified, frequently the coating on the asset will have aged or denatured in such a way that recoating the damaged portion with the original coating still creates a mismatch in color upon later inspection.

In general, paint manufacturers develop a large range of coatings with different colors, color variations, color effects, and the like, whether for the original automotive companies, or independently, such as to refinish assets painted with coatings from another manufacturer. The sheer volume and range of colors and coatings developed by paint manufacturers frequently provides a suitable overall color match with most damaged assets where basic color comparison on a display screen is the only consideration. Close inspection after application, however, frequently reveals small deviations in the colors that may not be apparent to the repair operator (e.g., auto-body operator), relevant front office manager, or the asset owner when looking at a color chip or computer display screen during the coating determination process.

For example, there may be differences owing to the color or physical characteristics of the underbody coating, or other effect pigments. Along these lines, flake, metallic, or other gonioapparent pigments added to the formulation can provide a mixed coating with a completely different overall color effect in certain lighting conditions than the same coating composition without the effect pigment. Moreover, while some coatings historically require multiple layers or added ingredients to achieve a particular effect, a new version of the coating may be made using a different technology that allows for the same visible effect but with fewer ingredients.

These differences in cost and makeup of coatings of certain colors that at first glance appear to be identical can create significant challenges for operators at an auto-body shop, and even for the asset owners. In general, there may be mismatches due to false positives. For example, a paint facility operator may select a closest match color based on the appearance on a display screen or paint chip that, on application, has a very different appearance in person. In other cases, there are no matches at all in the database, and the only appropriate solution may be a custom tint. Even in those cases, a custom tint derived through a graphical user interface may suffer from display screen characteristic deviations, again resulting in a potential mismatch upon final application. Such outcomes are present even with coating manufacturers that offer a wide range of paints, shades, and hues.

Thus, there are many opportunities for new methods and systems that better enable application of coatings on an asset.

### BRIEF SUMMARY

The present invention provides systems, methods, and computer program products described for efficiently and accurately estimating coating formulations in refinish of an asset, in part by enabling more realistic and accurate color matches. For example, the present invention comprises computerized systems employing methods for displaying a color and formula adjustment of an asset to be repainted. Colors can be matched using real-life color values retrieved from a database, or using custom colors by adjusting sub-components.

For example, a computer-implemented method for displaying a color and formula adjustment of an asset to be repainted can include providing via a digital display a graphical user interface comprising one or more selectable elements for retrieving spectrophotometer data measured from a target asset. The method can also include receiving spectrophotometer data from an end user of the graphical user interface, the spectrophotometer data retrieved from a hand-held spectrophotometric device connected to the digital display. In addition, the method can include retrieving from a database a plurality of closest match colors corresponding to the spectrophotometer data.

Furthermore, the method can include displaying on the graphical user interface a plurality of selectable color tiles corresponding to the retrieved closest match colors, and further displaying an image for each of one or more selectable sub-component options corresponding to one or more alternate formulas for at least one of the selectable color tiles. Still further, the method can include, upon selection of any of the one or more selectable sub-component options, displaying on the graphical user interface an adjusted image of the corresponding selectable color tile, wherein the adjusted image reflects an adjusted formulation of an initial color displayed by the selected color tile. Yet still further, the method can include, upon receipt of user selection through the graphical user interface of the adjusted image, displaying on the graphical user interface the adjusted formulation for the selected color displayed by the selected color tile.

An additional or alternative computer-implemented method for displaying a color and formula adjustment of an asset to be repainted can include providing through a display a graphical user interface comprising one or more selectable elements for retrieving spectrophotometer data measured from a target asset. The method can also include receiving spectrophotometer data from an end user of the graphical user interface, the spectrophotometer data of a target asset retrieved from a hand-held spectrophotometric device connected to the digital display. In addition, the method can include retrieving from a database a plurality of closest match colors corresponding to the spectrophotometer data. Furthermore, method can include displaying on the graphical user interface a plurality of selectable color tiles corresponding to the retrieved closest match colors, and further displaying an image for one or more selectable sub-component options corresponding to one or more alternate formulas for at least one of the selectable color tiles. Still further, the method can include, upon selection of any of the one or more selectable sub-component options, retrieving from the database a plurality of alternate formulas that are closest matched to the selected sub-component option and the corresponding selectable color tile. Yet still further, the method can include displaying an image of the retrieved plurality of alternate formulas in the form of corresponding selectable alternate color tiles.

Additional features and advantages will be set forth in the description which follows, and in part will be obvious from the description, or may be learned by practice. The features and advantages may be realized and obtained by means of the instruments and combinations particularly pointed out in the appended claims and aspects. These and other features will become more fully apparent from the following description and appended claims, or may be learned by the practice of the examples as set forth hereinafter.

### BRIEF DESCRIPTION OF THE DRAWINGS

In order to describe the manner in which the above recited and other advantages and features can be obtained, a more particular description briefly described above will be rendered by reference to specific examples thereof, which are illustrated in the appended drawings. Understanding that these drawings are merely illustrative and are not therefore to be considered to be limiting of its scope, the present invention will be described and explained with additional specificity and detail through the use of the accompanying drawings in which:

FIG. 1A illustrates an overview schematic of a system in which a plurality of systems coordinate color data and selection with a remote color database over a network, in accordance with the present invention;

FIG. 1B illustrates a schematic of one of the local systems of FIG. 1A, further illustrating components and modules implemented between a corresponding client and server, in accordance with the present invention;

FIG. 1C illustrates a schematic in which an end user interacts with the components shown in FIGS. 1A-1B to determine color values for an asset, in accordance with the present invention;

FIG. 2A illustrates a schematic in which a user provides various selections and adjustments pursuant to refining a matched color against an image of the original color, in accordance with the present invention;

FIG. 2B illustrates a schematic in which the user interacts with a user interface to further manipulate one or more sub-components of a selected color pursuant to finalizing a color match, in accordance with the present invention;

FIG. 3 illustrates a user interface that shows the various formula or color recipes components that a user can select pursuant to matching a virtual tint card with a scanned image of the original color, in accordance with the present invention;

FIG. 4 illustrates a flowchart of a method in accordance with the present invention for displaying a color and formula adjustment of an asset to be repainted; and

FIG. 5 illustrates a flowchart of an additional or alternative method in accordance with the present invention for displaying a color and formula adjustment of an asset to be repainted.

### DETAILED DESCRIPTION

The present invention provides systems, methods, and computer program products described for efficiently and accurately estimating coating formulations in refinish of an asset, in part by enabling more realistic and accurate color matches. For example, the present invention comprises computerized systems employing methods for displaying a color and formula adjustment of an asset to be repainted. Colors can be matched using real-life color values retrieved from a database, or using custom colors by adjusting sub-components.

For example, the present invention can provide a number of benefits to end users, such as operators of an asset repair facility (e.g., auto-body shop), front office workers managing a bidding system, or even asset owners looking to select an appropriate color at minimal cost. Such benefits can include improved and more efficient color matching used to refinish an asset, such as by enabling better, more realistic matching and interactive display of colors. Moreover, end users such as asset repair operators and even the end customer can gain confidence that a custom color designed through a graphical user interface will appear as expected on the finished product. The benefits can further include improved and more efficient pricing and estimation of asset refinish projects with accurately selected colors, thereby avoiding costly mistakes that necessitate further repair and repainting. One will appreciate that such efficiencies can have large, positive impacts on the environment through waste mitigation, such as by, at least in part, minimizing the amount of materials needed for any particular project.

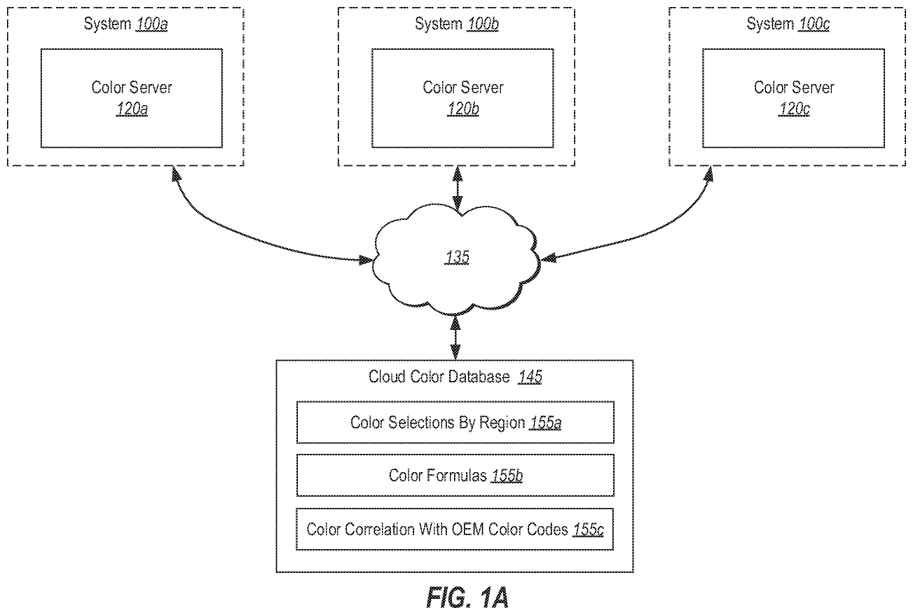

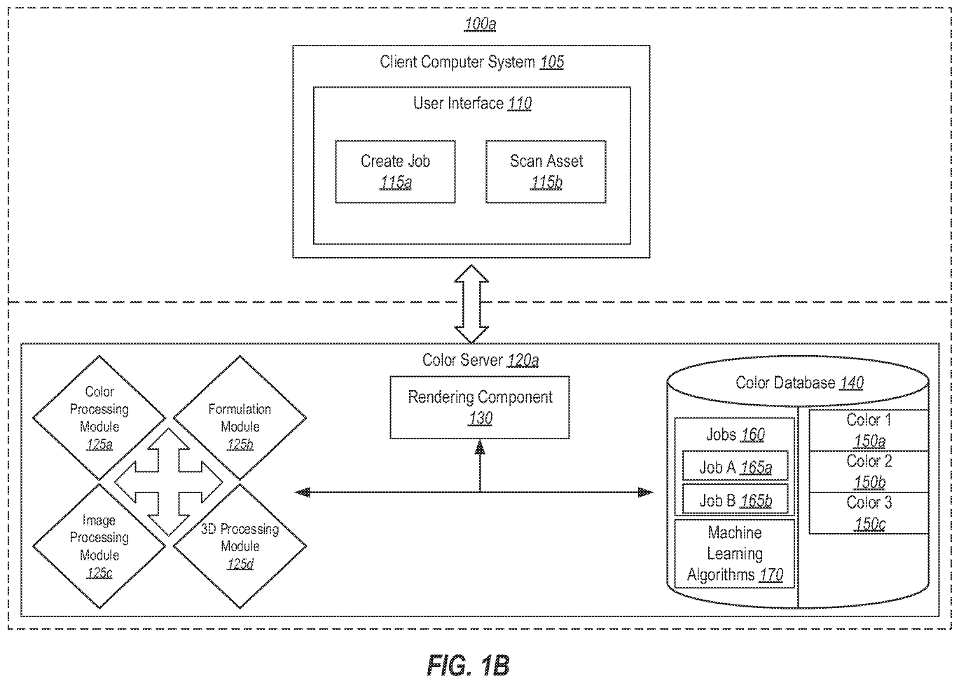

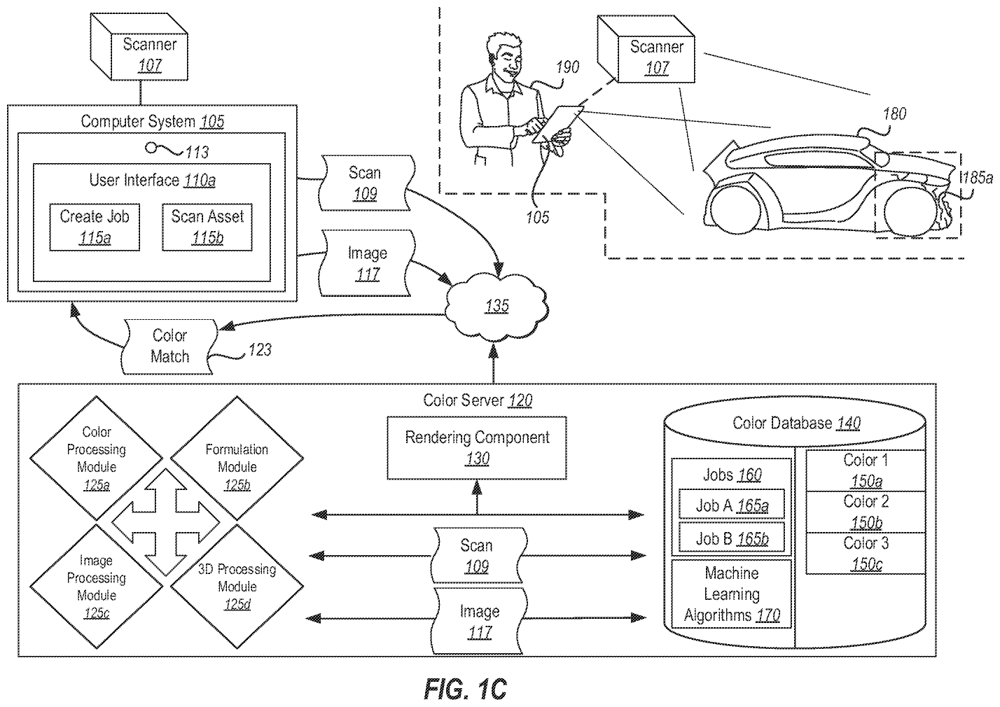

FIG. 1A illustrates an overview schematic of a system in which a plurality of individual or localized computer systems coordinate color data with a remote color database over a network. In particular, FIG. 1A illustrates an environment in which a plurality of systems 100(a-c) comprising local color servers 120(a-c) communicate and store data remotely over a network 135 with, for example, a cloud color database 145. As understood more fully herein, the various color servers 120a-c gather data corresponding to user selection, color matching, and asset repair at various asset repair shops, such as local auto-body shops. The color servers 120a-c can comprise one or more stand-alone computer systems, as well as an application or partition of a single device used by the local operator, such as an auto-body refinish operator, or front office worker. Moreover, the one or more devices on which the color server 120(a-c) resides may be installed locally at the asset repair shop, or remote thereto (e.g., a virtual machine), and thus accessible over network 135. The color servers 120a-c can comprise any number of digital computing devices, including but not limited to one or more laptops, tower computer systems, tablet computers, or personal device assistants, including mobile phones.

FIG. 1A further shows that the one or more color servers 120(a-c) interact over network 135 with one or more cloud color manager systems 145 (or simply “cloud color manager(s)”). In general, the cloud color manager(s) 145 similarly can include one or more remote computing devices that gather, process, and relay user selections, or recent updates to color profiles. Along these lines, FIG. 1A shows that the cloud color database 145 includes a component 155a for storing color selections by region. For example, cloud color database 145 can store data about coating components (e.g., formula/ingredients/parameters) and sub-components selected by users in the eastern United States to coat a car of one particular year, make, and model, as well as similar selections by other users in different parts of the United States (or in another region of the world) to coat the same car. That is, the cloud color database 145 can keep an ongoing, continually updated database for what colors or versions thereof users are selecting in Europe, Australia, Eastern Asia, South America, and so forth. This data can help account for regional and personal selection differences selected by region to obtain the same overall look and color feel, and/or to account for regional preferences and manufacturer specifications that result in desired end color or overall color appearance/effect.

FIG. 1A also shows that the cloud color database 145 can include a color formula component, such as the illustrated color formulas component 155b. The color formulas component 155b can include various ingredients, amounts, recipes, and cost information for a given coating, as well as pricing and physical data for each individual sub-component, such as continually updated costs of base of particular physical types, costs of effect pigment (e.g., XIRALLIC, gonioapparent pigment, metallic flake, mica, pearlescent pigments, and the like), and costs of various color tints. Coatings with greater or lower relative pricing, such as those with multiple coating layers (e.g., tricoat, XIRALLIC) can be marked as such in the stored record. The color formulas component 155b can further include various physical or raw data measured for each coating sub-component, such as spectral, colorimetric, or other data for various tints, base coats, and effect pigments, including such data as measured from various combinations of such sub-components. As discussed more fully herein, the color formulas component 155b can also include predicted spectral or colorimetric data for given formulas where actual measurements have not yet been performed.

In at least one embodiment, the color formulas component 155b includes raw physical measurements or predicted measurements (also referred to herein as “secondary color data”), such as spectral, or other colorimetric measurements including but not limited to CIELAB (i.e., L*a*b*) values, spectrophotometer reads, RGB, and gamma-RGB values, and/or XYZ tristimulus data, etc. for each coating, and each coating sub-component. In one or more additional or alternative embodiments, the color formulas component 155b includes a mixture of raw physical measurements for a number of coatings and coating sub-components, and predicted physical measurements for other coatings or coating sub-components based on measurements taken from adjacent colors, such as colors in the same color space, but perhaps differing by one or more sub-components (e.g., different base), or differing by slight changes in hue, chroma, or toner ratio. As understood more fully herein, a coating manufacturer can predict colorimetric or spectral physical values for a color based on interpolating such values in next closest colors, or predicting such values when one of more sub-components of a color contains known physical measurements while other sub-components of the color contain unmeasured sub-components.

In addition, FIG. 1A shows that the cloud color manager(s) 145 can include a component for correlating color with OEM color codes, namely the illustrated component 155c. In one instance, an operator, or automated update interface, can continually update cloud color database 145 with both historical and recent updates to an asset manufacturer's coating codes and formulations used to coat a particular asset. Thus, the cloud color database 145 can store information such as the coating color and formulation used to coat a piece of heavy industrial equipment in the year 1970, as well as that used for a particular automobile of a certain make, and model as created in the year 2021, and so on.

The cloud color database 145 can also store various secondary indicia associated with each color and color formulation. For example, the cloud color database 145 can store barcode, QR code, and/or VIN (vehicle identification number) data associated with each color record, which may enable an end user to scan the corresponding code on the asset itself, and then enable the user to pull the record for the original color as stored by the cloud color database 145. Pulling the full record for the original color can indicate all components/ingredients/layers, and other parameters known about the original coating application. The color database 145 can also serve as a central repository for the most recent updates of a coating manufacturer's colors and related physical data, such as formula, spectral, colorimetric, RGB, CIELAB, and/or XYZ tristimulus data and related conversion data, as well as image data, for each color and corresponding color sub-component used to make a particular coating.

The cloud color manager(s) 145 may also, for example, coordinate with one or more databases of one or more asset (e.g., auto) manufacturers (which may or may not be the coating manufacturer). This coordination can ensure the cloud color manager is able to regularly obtain similar formula, spectral, colorimetric, RGB, CIELAB, and/or XYZ tristimulus values (and related conversions) for each color used to coat the assets by the asset manufacturer as they are applied each year. The secondary and physical data corresponding to each color can be used to retrieve color matches as described more fully herein. For purposes of this specification and claims, “primary color data” refers to the color name or color code used to identify a particular coating, while “secondary color data” refers to data other than express color name or color code, such as barcode, QR code, or physical characteristic data associated with a particular coating.

FIG. 1B illustrates a schematic of one of the local systems of FIG. 1A, in this case system 100a, further illustrating components and modules implemented between a corresponding client and server. In general, each local system 100 (i.e., 100a-c, etc.) can comprise at least one client computer system 105 that communicates with a color server (i.e., 120a-c, etc.) For example, FIG. 1B shows that system 100a can comprise at least client computer systems 105 in communication with color server 120a. The client computer system 105 can comprise any number or type of portable or stationary computer device, including but not limited to a desktop computer system with an attached display/monitor, or a mobile computing device, such as a laptop, tablet computer, mobile phone, or other personal device assistant.

As previously indicated, FIG. 1B further shows that client computer system 105 is in communication with color server 120a. The color server 120a may comprise an application or virtual machine installed on the client computer system 105 itself, or may be an application installed on a separate, stand-alone computing system, such as a local or remote computer system connected to client computer system 105 over a local or global network. In particular, network 135 may be a global, wide, or local area network, including the Internet. FIG. 1B further shows that the color server 120a comprises a number of modules (e.g., 125a-125d), components (e.g., 130), and databases (e.g., 140) that assist in management and relay of relevant color data viewed by the client system 105.

In general, modules 125(a-3) and components 130 will be understood as abstractions of generalized processing components that can be used in at least one implementation of the present invention, and there may be more or fewer than those illustrated and described, and as may be suited for a particular server and cloud operating environment. As used herein, a “module” means computer executable code that, when executed by one or more processors at a given computer system (e.g., computer system 105, or server 120), causing the given computer system to perform a particular function. By contrast, a “component” means a passive set of instructions or data structures or records that store, manage, and/or otherwise provide information handled through a given module. One of skill in the art, however, will appreciate that the distinction between a different modules or components is at least in part arbitrary, and that modules or components may be otherwise combined and divided and still remain within the scope of the present disclosure. As such, the description of a component as being a “module” or a “component” is provided only for the sake of clarity and explanation and should not be interpreted to indicate that any particular structure of computer executable code and/or computer hardware is required, unless expressly stated otherwise. In this description, the terms “component,” “agent,” “manager,” “service,” “engine,” “virtual machine” or the like may also similarly be used.

In any event, FIG. 1B shows that color server 120a can further comprise one or more color databases 140, which may itself include one more additional data stores, such as the jobs data store component 160, a data store for a set of color records 150(a-c), and a data store for storing and accessing one or more machine learning algorithms 170. In general, color server 120 can employ machine learning algorithms 170 with any number of the modules 125(a-d) as applicable to identify asset defects (e.g., a crashed or damaged portion of an asset), to learn from the prior human input (described above) identifying the area needing report, predict colorimetric or physical data for custom coatings, or unmeasured coatings, and improve analysis expertise over time. Such machine learning algorithms 170 can comprise but are not limited to algorithms understood as supervised learning algorithms, unsupervised learning algorithms, semi-supervised learning algorithms, reinforcement learning algorithms, self-learning algorithms, feature learning algorithms, anomaly detection algorithms, robot learning algorithms, and/or composite versions thereof.

FIG. 1C illustrates a schematic in which an end user interacts with the components shown in FIGS. 1A-1B to process an asset for eventual refinish. As shown, user 190 interacts with a user interface 110a displayed on computer system 105. FIG. 1C further shows that computer system 105 comprises one or more image capture elements 113. Image capture element 113 may be integrated with computer system 105, as shown, or alternately connected to the computer system 105, such as via a wired (e.g., USB, ethernet) or wireless (e.g., WIFI, Bluetooth, etc.) connection. FIG. 1C also shows that computer system 105 can be connected to a scanner 107, and one will appreciate that this can also be connected similarly via a corresponding wired or wireless connection. In one implementation, one or both of scanner 107 and image capture element 113 is/are connected over to a cloud server over a network (e.g., Internet) connection, such as to color server 120 over network 135, and computer system 105 accesses the corresponding images or scan data from the color server 120 indirectly over network 135.

In any case, FIG. 1C shows that user interface 110a displays a plurality of selectable elements 115a, 115b, etc. for creating a job corresponding to repair of asset 180. In one implementation, user 190 captures data corresponding to the asset 180 to be repaired, in this case the illustrated portion 185a showing physical damage. One will appreciate that “damage” is not limited to ordinary physical damage owing to impact/deformation of the asset 180 necessarily, but may also include areas of discoloration, such as fade, rust, or other forms of coating degradation or coating imperfection, which might trigger a given user 190 to recoat or refinish all or part of the asset 180. In addition, one will appreciate that implementations of the present invention are not limited to refinish or recoating of damaged assets, as such, and that an end user 190 may be performing another type of project, such as building and painting an asset from scratch or from scrap parts, building a kit car, or simply painting an existing asset entirely just to change its color. Nevertheless, the present invention is described herein primarily with respect to refinish of an asset 180 needing repair for purposes of convenience.

In at least one method of operation, user 190 opens user interface 110a, and selects selectable element 115a for creating a job. User 190 then uses the image capture element 113 to snap an image of the asset 180 to be repaired, including the damaged portion 185a. User 190 can also select the selectable asset 115b to scan the asset, and then scans the asset 180, and/or damaged portion thereof 185a to identify color and other secondary color data/indicia. For example, upon selecting element 115b, user deploys scanner 107 (or image capture element 113) to scan a barcode, QR code, or VIN element presented on the asset 180. Along these lines, some asset manufacturers now include computer-readable or scannable information embedded within barcodes or QR codes affixed to an inside of a door jamb along with or beside a VIN for the given asset. In other cases, scanner 107 comprises a colorimeter or spectrophotometer, such as provided by any number of other instrument manufacturers. In at least one implementation, the scanner 107 comprises a portable, hand-held spectrophotometer or other colorimeter connected to computer system 105 via suitable cable such as USB, or is connected wirelessly via Bluetooth, WIFI, or other suitable communication protocol.

In either case, FIG. 1C further shows that computer system 105 provides the capture image data (typically in RGB format) from the device camera to color server 120 via one or more messages 117. In addition, FIG. 1C shows that the user 190 scans all or part of the asset 180 needing repair. In one implementation, the user 190 scans with the scanner 107 only the non-damages portions of the automobile, whereas in other implementations the user 190 scans the damaged area of the asset 180 to be repaired. The user sends the scanned data including any or all the various scans including spectral data and/or colorimetric data. The scan can also include barcode, VIN, or QR code data as applicable. The user then sends the scanned data via one or more corresponding messages 109 to color server 120.

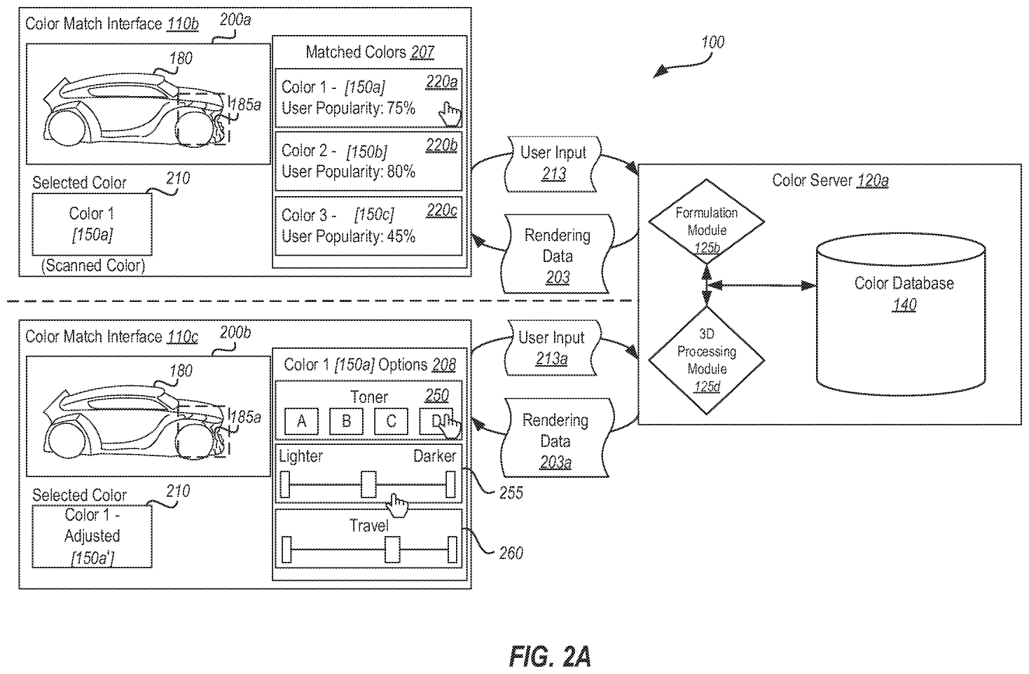

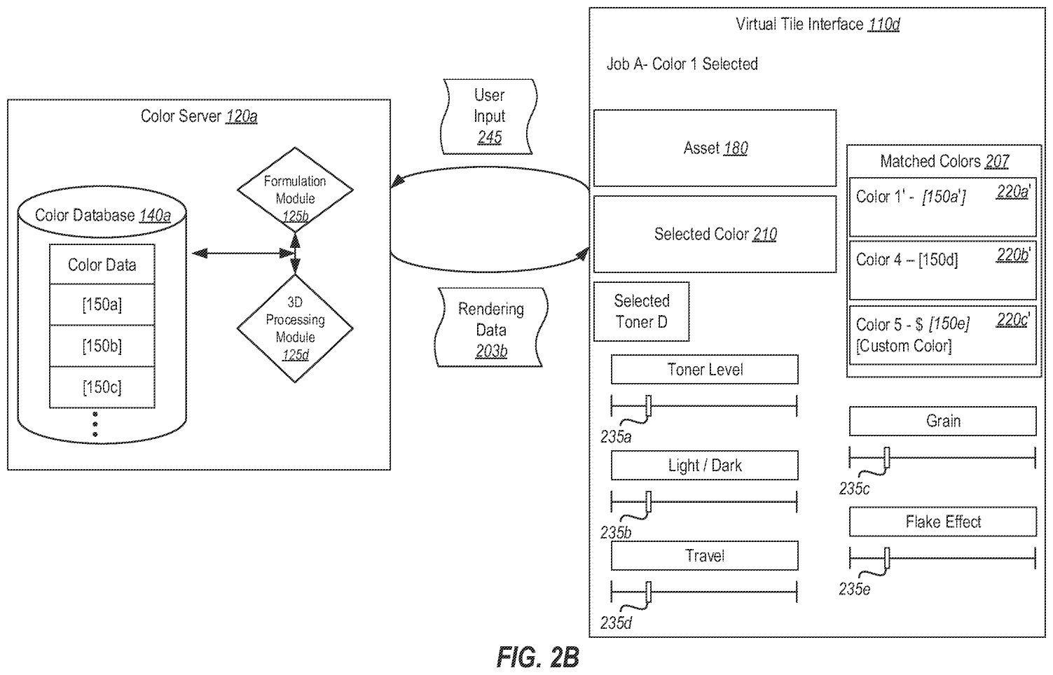

Color server 120 can then process the received data from one or both of messages 117 and 109. For example, color server 120 can store the physical color data associated with either or both of scan 109 and image 117 through the color database 140, such as by initiating a job (e.g., “Job A”) record in the corresponding Jobs 160 data structure. Generally speaking, however, the data in message 117 will comprise RGB image data, whereas the data in scan 109 will comprise secondary color data, such as spectral or colorimetric data. The color server 120 can also process the data in any of the processing modules 125a, 125b, 125c, and/or 125d. For example, in one implementation, formulation module 125b coordinates receipt of image 117 and scan 109, and prepares a data structure for later use by the formulation interface 110b (e.g., FIG. 2A).

In addition, the image processing module 125c can perform object and/or segmentation analysis via one or more machine learning algorithms 170 to identify and draw lines around areas that the machine learning algorithms automatically identified for the presence of damage or defect, (i.e., area/portion 185a). In addition, color processing module 125a can perform a number of analyses of the image, spectral, and/or colorimetric data received to identify relevant, closest color matches among colors 150a, 150b, and 150c stored in color database 140. For example, color processing module 125a can identify that information received in scan data 109 includes colorimetric and/or spectral data that corresponds to a particular coating color stored in color database 140 for a particular make, model, and year of an automobile, and further identify from the color database which particular undercoat(s) and pigment effects were used in the formula for that particular color record.

Similarly, color processing module 125a can determine that the original coating identified in the scan data 109 is not one created by the paint manufacturer and thus stored in the color database 140, but that several other colors that have similar secondary color data by comparison of physical characteristics, such as similar spectral, CIELab, and/or XYZ tristimulus value matches. Color processing module 125a can then gather those color records that match or otherwise fit within an acceptable range of deviation from the actual measurement, and provide that as a response for further user input. Color processing module 125a can also use one or more machine learning algorithms 170 to predict expected physical values, such as colorimetric and/or spectral values for a formula where that data are not already known, as discussed more fully herein. In any case, FIG. 1C shows that color server 120 then sends one or more responses back to computer system 105 in the form of one or more color match messages 123. As discussed more fully herein, computer system 105 can then enable the user to interact with the proposed color matches through user interface 110a.

For example, FIG. 2A illustrates a schematic in which computer system 105 renders an update to the user interface 110, namely through display of user interface 110b. User interface 110b can be provided to the original user 190, or to another operator, or to a client interesting in adjusting the color matches. It is not required that user interface 110b and the original user interface 110a be sequentially handled by the same person or entering entity. For example, in one implementation, one auto-body operator performs the initial intake with the scanner 107 and image capture element 113, while another auto-body operator separately enters estimate or formulation data in user interface 110b. In still another implementation, a front office worker that is in the same location or remote of the auto-body operator can perform one of these scanning or and color formulation or modification steps separately before the asset 180 is received at the asset repair shop.

In either case, FIG. 2A shows that user interface 110b comprises an interactive display of 200a of asset 180. For example, through one or more selectable elements (not shown) in a prior user interface, a user continues with one or more selections for comparing matched colors to an image of asset 180. Accordingly, user interface 110b pulls the image data taken originally from image capture element 113 (or other device) for asset 180, and loads an interactive display 200a. In one implementation, the interactive display 200a includes an image of just a portion of asset 180, or a representative image of just a portion of panel (e.g., a tile) showing the color and effect as retrieved from the image file. In another implementation, interactive display 200a shows an interactive image of the entire asset 180 as photographed, along with the damaged portion 185a.

FIG. 2A further shows that interface 200a includes one or modifiable more color tiles 210 corresponding to a selected color tile 210. For example, FIG. 2A shows that selected color tile 210 shows an original, scanned color (150a), which in this case provides as a starting point using an image file rendered for the original, scanned color. This rendering data 203 can be received via one or more messages from color server 120a. In one implementation, the received rendering data 203 includes original image information received via prior messages 117, and/or scan information 109. For example, rendering data 203 can comprise the relevant data points of messages 109 and 117 that have been rendered by rendering component 130 for display.

FIG. 2A also shows that the interactive display 200a displays a rendering of asset 180 and can further include a designation of the damaged portion, namely portion 185a. As previously indicated, the designated portion 185a can be automatically determined by the image processing module 125c and relevant machine learning algorithms 170. Alternatively, or in connection with machine learning algorithms, the user can use the interface 200a to draw a line around the damaged portion shown in the interactive display 200a. The computer system 105 can then make determinations based on the exhibited damage and number of underlying parts known for this portion of asset 180 to automatically determine the number of panels and parts that will need to be replaced. For example, cloud color database 145 may store a list of parts needed to replace panels at varying levels of damage for various makes, models, and years, of various assets.

FIG. 2A further illustrates a set of various color options in the form of a set of matched colors 207. In particular, FIG. 2A shows that the matched color interface 207 displays a color tile 220a, 220b, 220c for each of the matched colors (i.e., Color 1-150a, Color 2-150b, and Color 3-150c, respectively) deemed to be closest to the color of asset 180, namely the original scanned color. The data displayed in the matched color tiles 220a, 220b, 220c can further include additional metrics, such as user popularity, cost, and basic ingredient information, such as the base type, flake type, or that the color comprises multiple layers (e.g., a tricoat color), etc.

For example, color tile 220a displays a “75%” popularity, while color tile 220b displays an “80%” popularity rating, and color tile 220c displays a “45%” popularity rating. These popularity ratings can be further distinguished based on region, and further divided based on selections by users (e.g., asset owners) or third-party payors (e.g., insurance). For example, upon selection of color tile 220b, the matched color interface 207 might further display an indication that Color 2 carries a popularity of 90% among asset owners in the southern United States, but only a 20% popularity among third-party payors in the same region, or perhaps a 55% popularity by end users in a similar climate but different country in the world. These sorts of metrics can help end users, asset repair shops, and front office personnel make informed decisions that can directly impact not just the cost of repair, but the extent to which a repair is likely to be paid in full by insurance, or likelihood a repair is likely to be visually accepted by an end user after application.

An asset repair shop may alternately present the matched colors interface 207 to an asset owner, along with the various color, cost, and popularity metrics. The asset owner, rather than the asset repair operator, may decide to select a slightly less popular color match (i.e., “Color 1”) due to its lower cost but nevertheless acceptable overall appearance. Similarly, the asset owner may alternately select the more expensive, more popular option, knowing that a third-party payor may only reimburse a small portion of the cost of repair and thus that the asset owner may be required to provide an up-front payment for the remainder. At least in part since the user can toggle the interactive interface 200b to show asset 180 displayed in interactive 3D with each of the matched colors on selection, and since the color selection is likely to be far more accurate by relating to colorimetric, spectrophotometric, and/or OEM color matching of the car in its present state, the color selection and modification process saves significant cost and effort for both the repair operator and the end-user, as well as any other third-party payors. That is, accurate interactive display, among other things, can ensure that initial cost estimates are more likely to reflect the final end price since the colors and costs presented to the user and asset repair personnel are more likely to reflect the actual color upon application, and thus accepted.

In some cases, however, the color tile 210 showing the scanned color may still not be close enough to what the user perceives to be the expected color, or the color shown for the asset 180 in interface 200a. Accordingly, at least one embodiment of the present invention further provides for various color customization tools to ensure that the end user (body shop operator, customer, etc.) is confident in the final color selection. For example, FIG. 2A shows that, upon selection of a matched color tile (e.g., 220a), the color match interface 110b can be updated to interface 110c (FIG. 2A, below), which provides a set of fine adjustment tools 208. FIG. 2A denote these tools 208 as “Color 1 [150a] Options,” meaning a tool set to adjust the selected “Color 1,” referencing database color “150a.” FIG. 2A further shows that the exemplary fine adjustment tools can include various sliders for the selected color, namely a toner selection tool 250, a lightness selection tool 255, and a “travel” selection tool 260. For purposes of this specification and claims, the term “travel” (aka “flop” or “color travel”) refers to the change in reflectance of a color over a range of viewing angles of the same target/asset. A higher level of travel is associated with coatings with metallic effect, whereas a lower level of travel approaches a more basic, solid color.

In general, the system 100 receives user adjustments to the selected color via user interface 110c as further user input 213a. For example, FIG. 2A shows that the user enters an adjustment through the toner selection tool 250, such as by selecting toner “D” for editing. FIG. 2A further shows that the user can adjust various sliders to adjust the selected toner, such as via sliders 255 and 260. In particular, a user can use slider 255 to adjust the lightness of toner “D” or of the overall Color 1, as desired, and can similarly adjust the color travel slider 260, such as by increasing the color travel to be higher or lower. These user adjustments cause the computer system 105 to send one or more user input messages 213a back to color server 120a, which can then return revised rendering instructions back via one or more output messages 203a. The color match interface 110c can then provide a rendering of the adjusted color via the selected color tile 210. For example, FIG. 2A shows that color tile 210 is adjusted in color match interface 110c to show adjusted Color 1, i.e., “150a′.” Thus, color tile 210 of the selected color shows whatever rendering information is received from color server 120a.

There are several ways that color server 120a can provide the relevant rendering information via the one or more messages 203, 203a, etc. In one exemplary embodiment, for example, color database 140 comprises relevant colorimetric data and spectral reflectance data for each color record (e.g., 150a 150b, 150c, etc.) Thus, for each user adjustment to the color (e.g., via the sliders within the color options 208 section), color server 120 compares the user-specified values via user input 213, 213a, etc. using the formulation module 125b to find one or more color records in color database 140 that best fit of all datapoints, and then passes the relevant colorimetric and/or spectral data to 3D processing module 125d. The 3D processing module 125d then determines the relevant rendering data corresponding to the provided colorimetric and/or spectral data, and passes the rendering data (e.g., RGB) back via message 203, 203a, etc.

In another exemplary embodiment, color server 120a can use formulation module 125b and/or 3D processing module 125d to prepare predicted rendering information based on the expected colorimetric data corresponding to the user selections. For example, the user input 213, 213a may comprise sufficient adjustment and modification to an initially matched color that there may not exist a sufficiently close match in color database 140 relevant to toner concentrations, lightness darkness, and travel, or other metrics. For example, matches provided in the matched colors section 207 may be based on statistical standard deviations of the actual or predicted colorimetric data determined through a user selection compared to actual colorimetric data in closest match records. In such cases, formulation module 125b can interpolate and generate colorimetric values for the user-modified color using adjustments of colorimetric and spectral data in other closest match records. The color server 120a can then pass the interpolated colorimetric and/or spectral data to 3D processing module 125d to generate corresponding RGB rendering data based off the interpolated, predicted physical response data. This may enable a user to essentially create a custom color and paint with relative confidence that the visually displayed color will ultimately match the current color of the asset, e.g., such as shown by the image of asset 180.

Still further additional or alternative embodiments can include steps that provide combinations of these processes. For example, color server 120a can be configured to render known colorimetric and spectral data in records 150(a, b, c, etc.) that match or at least closely match a user's selection within a predefined threshold. For those user modifications that place the selected color outside of the given threshold, color server 120a can then create predicted colorimetric information and rendering data. In still further embodiments, color server 120a may provide rendering data only for matching records with known colorimetric information, leaving the user essentially to select only those color records that are presently available by the paint manufacturer. However the colorimetric and/or spectral data is generated or retrieved, color server 120a provides relevant rendering that is reflected in color tile 210.

FIG. 2B illustrates an embodiment in which the end user can provide still further fine adjustments to the selected color, or color sub-component. For example, in addition to the interfaces 110a, 110b, and 110c, FIG. 2B shows that the user can open another interface 110d (i.e., a virtual tile interface), which enables the user to provide further modifications in this case to the selected toner component “D.” In this case, FIG. 2B further shows an embodiment of the matched colors interface 207, which shows a continually updated pallette of matched database colors based on the user selections. That is, virtual tile interface 110d provides additional slider tools 235(a-e) for modifying the selected toner D, including toner level slider 235a, lightness/darkness slider 235b, graininess slider 235c, color travel slider 235d, and flake effect slider 235e. For purposes of this specification and claims, “grain” or “graininess” refers to an property of a surface appearing to have particular or grain-like elements found in natural materials, such as stone or wood. For purposes of this specification and claims, a “flake effect” refers to a property of having more or fewer light reflecting elements, such as with metallic flake elements providing a glitter or glint effect with more or less density, depending on the amount selected.

In at least one embodiment, when the user selects input corresponding to any of the sliders 235(a-e), the virtual tile interface 110d sends one or more messages 245 containing the relevant user input/color modifications to color server 120a. In turn, color server 120a processes the user input 245 via the methods described above, either by identifying closest match physical characteristic data (colorimetric and/or spectral reflectance) found in color database 140a, or by generating predicted physical data based on interpolation with known formulas. For example, if the user adjusted an amount of toner D with a certain flake effect level, the user adjustment could be used by color server 120a to predict a custom paint formulation (e.g., with formulation module 125b), and then use that formulation to find similar matches in color database 140a.

Virtual tile interface 110d can then update the matched colors interface 207 so that the closest matching colors are Color 1′ corresponding to color record 150a′, Color 4 corresponding to color record 150d, and a Color 5 corresponding to a newly created record 150e, representing a custom color that has not yet been made. Custom colors or other deviations from known color records in database 120a may be appropriate where aging or other discoloration throughout asset 180 renders finding an exact match in any system nearly impossible, or in other cases where a user simply prefers a particular color or color effect that has not yet been created. However created or selected, virtual tile interface 110d receives rendering data via one or more response messages 203b. Virtual tile interface 110d then displays the selected color in the selected color tile 210, which may be juxtaposed with an image of the scanned color corresponding to asset 180 for reference.

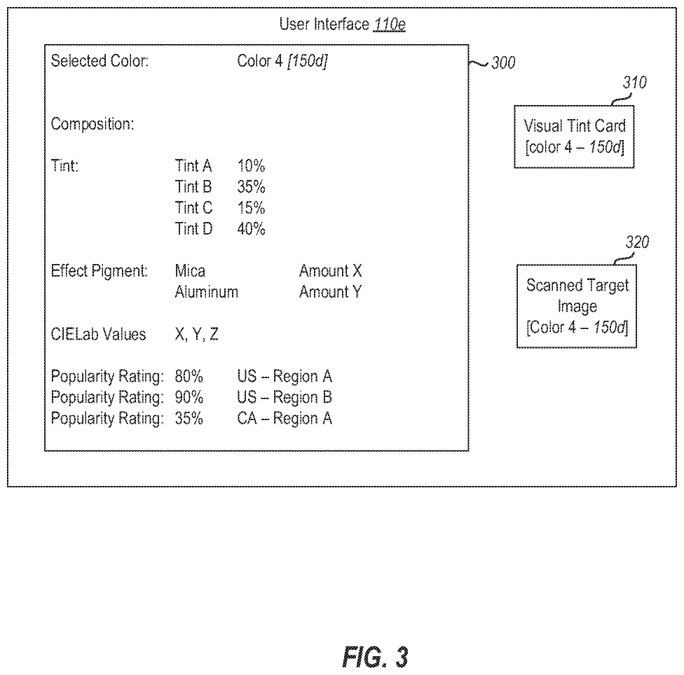

Upon final selection of the color, the system 100 can then provide a formulation interface 110e shown on the user device. For example, FIG. 3 shows that user interface 110e includes a final selection and relevant formulation data for the finally selected color, in this case Color 4 corresponding to color record 150d. To this end, FIG. 3 provides a visual tint card 310 corresponding to the finally determined Color 4, and a separate, adjacent tile 320 corresponding to the actual, scanned color. FIG. 3 further shows the relevant formulation information corresponding to Color 4. For example, FIG. 3 shows the relevant tint amounts, and relevant effect pigment amount. FIG. 3 further shows the given physical values that correspond with this formulation, such as by showing CIELab Values for this formulation. In additional or alternative embodiments, this display can further show comparative CIELab or other reflectance value information corresponding to tint card 310 and tint card 320, so that both tint cards are shown visually and with numerical comparisons.

FIG. 3 shows that in this or alternative embodiments, user interface 110e can further provide popularity ratings for this selected color, as previously described. These popularity ratings can be determined on a global basis and stored in color server 120a. Popularity ratings can enable the end user to determine whether the selected color is similar to what others have selected in various regions, providing yet further information in the final determination.

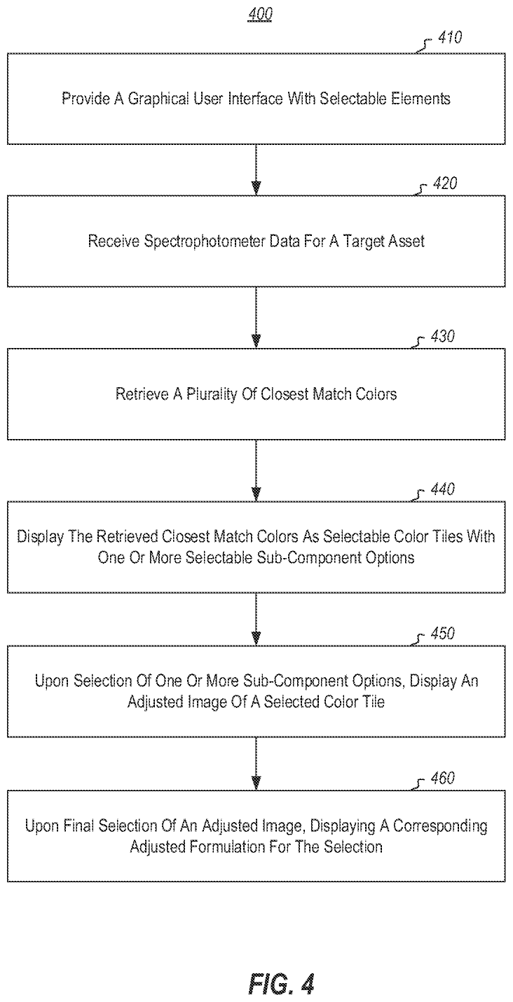

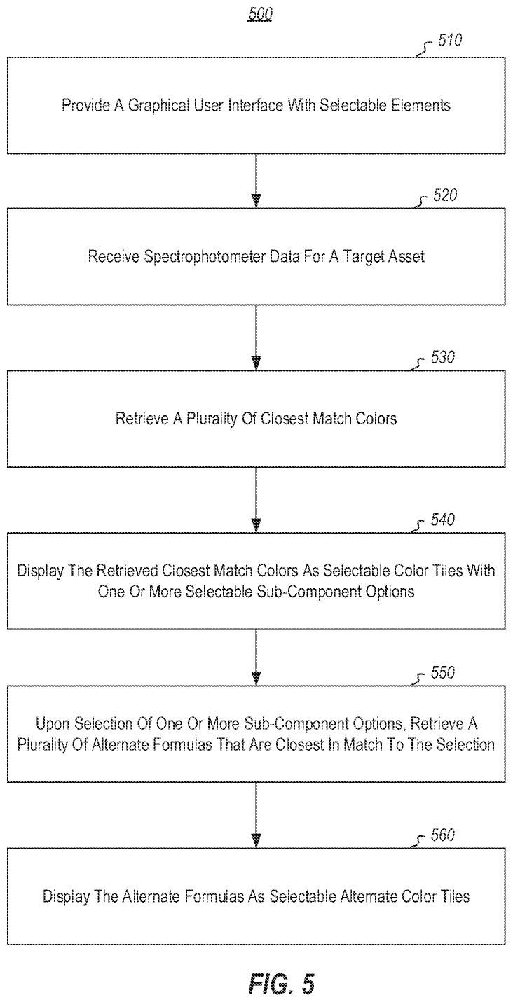

Accordingly, FIGS. 1A through 3 provide multiple components, modules and schematics as part of a system for efficiently providing accurate refinish compositions that are reflective of true to life appearance and other considerations, thus significantly eliminating costly environmental waste and lost time needed to correct and refinish otherwise inaccurate or unwanted selections. The present invention can also be described in terms of one or more methods for accomplishing a particular result. Along these lines, FIGS. 4 and FIG. 5 illustrate various methods for providing an accurate, just-in-time estimate of an asset to be repainted. The acts and steps FIGS. 4 and 5 are discussed below with reference to the systems components and modules of FIGS. 1A-3.

For example, FIG. 4 illustrates that a method 400 of for displaying a color and formula adjustment of an asset to be repainted can comprise an act 410 of providing a graphical user interface with selectable elements. Act 410 includes providing via a digital display a graphical user interface comprising one or more selectable elements for retrieving spectrophotometer data measured from a target asset. For example, FIG. 1C shows that a user opens user interface 110(a-d) using computer system 105, where the user interface provides various selectable elements 115a, 115b, 220(a-c), 208, 255, 260, etc., which enables the user to engage an attached spectrophotometer, and then interact with provided color matches.

FIG. 4 also shows that method 400 can comprise an act 420 of receiving spectrophotometer data for a target asset. Act 420 includes receiving spectrophotometer data from an end user of the graphical user interface, the spectrophotometer data retrieved from a hand-held spectrophotometric device connected to the digital display. For example, FIG. 1C shows that the user 190 uses connected scanner 107 to scan target asset 180 and its damaged portion 185a.

In addition, FIG. 4 shows that method 400 can comprise an act 430 of retrieving a plurality of closest match colors. Act 430 includes retrieving from a database a plurality of closest match colors corresponding to the spectrophotometer data. For example, after user 190 scans asset 180, the user interface 110 displays a set of matched colors 207, which are retrieved from color database 140.

Furthermore, FIG. 4 shows that method 400 can comprise an act 440 of displaying the retrieved closest match colors as selectable color tiles with one or more selectable sub-component options. Act 440 includes displaying on the graphical user interface a plurality of selectable color tiles corresponding to the retrieved closest match colors, and further displaying an image for each of one or more selectable sub-component options corresponding to one or more alternate formulas for at least one of the selectable color tiles. For example, as shown in FIGS. 2A and 2B, the user can select toner adjustment in terms of an overall lightness/darkness slider 255 or color travel slider 260, and can further modify a specific toner using toner-specific sliders 235a, 235b, 235c, 235d, and/or 235e.

Still further, FIG. 4 shows that method 400 can comprise an act 450 of, upon selection of one or more sub-component options, displaying an adjusted image of a selected color tile. Act 450 includes, upon selection of any of the one or more selectable sub-component options, displaying on the graphical user interface an adjusted image of the corresponding selectable color tile, wherein the adjusted image reflects an adjusted formulation of an initial color displayed by the selected color tile. For example, FIG. 2A shows that interface 110b provides a tile 210 showing the initially selected color, in this case 150a, which is based on the originally scanned color for asset 180. FIG. 2A also shows that, upon modification (e.g., interface 110c), the selected color tile 210 shows an updated version of the selected or scanned color, i.e., color 150a′.

FIG. 4 also shows that method 400 can comprise an act 460 of, upon final selection of an adjusted image, displaying a corresponding adjusted formulation for the selection. Act 460 includes, upon receipt of user selection through the graphical user interface of the adjusted image, displaying on the graphical user interface the adjusted formulation for the selected color displayed by the selected color tile. For example, FIG. 3 shows that, upon final selection, the user interface (e.g., 110e) can display a formula listing 300, where the formula listing includes the various sub-components, amounts, and expected (or actual, if known) physical effect values, such as CIELab values, spectral values, etc. The user interface 110e can further show the predicted color versus the scanned original color via display tiles 310 and 320.

In addition to the foregoing, FIG. 5 illustrates that an additional or alternate method 500 for displaying a color and formula adjustment of an asset to be repainted can comprise an act 510 of providing a graphical user interface with selectable elements. Act 510 includes providing through a display a graphical user interface comprising one or more selectable elements for retrieving spectrophotometer data measured from a target asset. For example, as previously noted, FIGS. 1B through 3 illustrate that client computer system 105 can display various user interfaces 110 (including user interfaces 110a-110e), which in turn display various selectable elements (e.g., color tiles 220a-220c, 220a′-220c′, options 208, and various slider options 255, 260, and 235a-e).

FIG. 5 also shows that method 500 can comprise an act 520 of receiving spectrophotometer data for a target asset. Act 520 includes receiving spectrophotometer data from an end user of the graphical user interface, the spectrophotometer data of a target asset retrieved from a hand-held spectrophotometric device connected to the digital display. For example, as previously described, user 190 can use computer system/device 105 and connected scanner 105 to obtain spectrophotometer or other colorimetric data from target asset 180.

In addition, FIG. 5 shows that method 500 can comprise an act 530 of retrieving a plurality of closest match colors. Act 530 includes retrieving from a database a plurality of closest match colors corresponding to the spectrophotometer data. For example, FIG. 2A shows that, in response to receipt of the scanned data of target asset 180, i.e., messages 109, 117, color server 120a provides a response from color database 140 showing the closest match colors, received via one or more message 123.

Furthermore, FIG. 5 shows that method 500 can comprise an act 540 of displaying the retrieved closest match colors as selectable color tiles with one or more selectable sub-component options. Act 540 includes displaying on the graphical user interface a plurality of selectable color tiles corresponding to the retrieved closest match colors, and further displaying an image for one or more selectable sub-component options corresponding to one or more alternate formulas for at least one of the selectable color tiles. For example, FIGS. 2A and 2B illustrate that the matched colors section 207 provide various color tiles 220a, 220b, 220c, etc. The user can select one of the color tiles 220(a-c) to create a modifiable color tile 210 showing the selected color, and then use various sub-component option adjustments in the form of selection icons 250, and/or sliders 255, 260, and/or 235a-235e.

Still further, FIG. 5 shows that method 500 can comprise an act 550 of, upon selection of one or more sub-component options, retrieving a plurality of alternate formulas that are closest in match to the selection. Act 550 includes, upon selection of any of the one or more selectable sub-component options, retrieving from the database a plurality of alternate formulas that are closest matched to the selected sub-component option and the corresponding selectable color tile. For example, selection of the relevant sub-component option adjustments can result in retrieving relevant colorimetric data from color database 140, or in some cases generating predicted colorimetric data. Either way, the colorimetric data is used for rendering by 3D processing module 125d, and the color server 120a then sends the rendering instructions back to computer system 105 for user view.

Along these lines, FIG. 5 shows that method 500 can comprise an act 560 of displaying the alternate formulas as selectable alternate color tiles. Act 560 includes displaying an image of the retrieved plurality of alternate formulas in the form of corresponding selectable alternate color tiles. For example, in FIG. 2A, the initial scan via scanner 107 results in user interface 110b displaying the initial matches in the form of color tiles 220a, 220b, and 220c. Whereas FIG. 2B shows that, upon user modification, the set of matched colors 207 is adjusted to reflect various revised matches in the form of color tiles 220a′, 220b′, and 220c, which correspond to adjustments of the original colors 1, 2, or 3, or completely different colors 4 or 5, where at least one of the colors (i.e., color tile 220c′) represents a new, custom color. In general, these color tiles 220(a-c) can include an image (actual or predicted) of the subject color, or simply a name or color code corresponding to the color.

One will appreciate, therefore, in view of the present specification and claims that the present invention can be practiced in a wide range of settings to provide accurate, just-in-time, contextually related information for generating accurate user color selections for use in coating applications. One will further appreciate that the present invention can be implemented in a wide range of settings. For example, in addition to the automotive-style asset repair analyses described herein, the present invention can be applied to defect analysis and repair employed in a wide range of assets, including heavy industrial and light industrial equipment, as well as in residential use.

The present invention can also be practiced with respect to more traditional facilities in the form of roofed buildings, such as to identify degradation/corrosion in or on buildings, and/or with coil steel, metal roofs, and other structural components. The present invention (in particular principles of artificial intelligence) can further be used to identify a particular color, or even quality of a color match, such as may be used in automotive and residential coating matches. Still further, the present invention can be used in connection with style transfer, namely transferring a photo-realistic image of a style of one picture into another one. One will appreciate therefore that principles of the present invention can be applied not just to maintenance, but also to general principles of quality assessment and assurance in a wide range of both industrial and personal use settings.

The present invention may comprise or utilize a special-purpose or general-purpose computer system that includes computer hardware, such as, for example, one or more processors and system memory, as discussed in greater detail below. The scope of the present invention also includes physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAS, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

A cloud-computing environment, or cloud-computing platform, may comprise a system that includes one or more hosts that are each capable of running one or more virtual machines. During operation, virtual machines emulate an operational computing system, supporting an operating system and perhaps one or more other applications as well. Each host may include a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

In view of the foregoing, the present invention may be embodied in multiple different configurations, as outlined above, and as exemplified by the following aspects.

In a first aspect, a computer-implemented method for displaying a color and formula adjustment of an asset to be repainted can include providing via a digital display a graphical user interface comprising one or more selectable elements for retrieving spectrophotometer data measured from a target asset; receiving spectrophotometer data of an asset to be repainted from an end user of the graphical user interface, the spectrophotometer data retrieved from a hand-held spectrophotometric device connected to the digital display; retrieving from a database a plurality of closest match colors corresponding to the spectrophotometer data; displaying on the graphical user interface a plurality of selectable color tiles corresponding to the retrieved closest match colors, and further displaying an image for each of one or more selectable sub-component options corresponding to one or more alternate formulas for at least one of the selectable color tiles; upon selection of any of the one or more selectable sub-component options, displaying on the graphical user interface an adjusted image of the corresponding selectable color tile, wherein the adjusted image reflects an adjusted formulation of an initial color displayed by the selected color tile; upon receipt of user selection through the graphical user interface of the adjusted image, displaying on the graphical user interface the adjusted formulation for the selected color displayed by the selected color tile.

In a second aspect of the computer-implemented method as recited in aspect one, the sub-component options can include a blend adjustment tool corresponding to adjustment of a ratio of a first sub-component relative to at least a second sub-component; and user adjustment of the blend adjustment tool through the graphical user interface displays the selected color tile with a new color reflecting an adjusted ratio of the first and second sub-components.

In a third aspect, the computer-implemented method as recited in any one of the preceding aspects one through two can further include displaying the selected color tile as a 3D tile with one or more curves.

In a fourth aspect, in the computer-implemented method as recited in any of aspects one through three, the sub-component options can include a tint adjustment tool corresponding to any of: (i) chroma, (ii) hue, or (iii) lightness of a tint in the adjusted image; and user adjustment of the tint adjustment tool through the graphical user interface adjusts display of the initial color corresponding to the selected color tile.

In a fifth aspect, in the computer-implemented method as recited in any of the preceding aspects one through four, the sub-component options can include an effect adjustment tool corresponding to any of: (i) travel, (ii) graininess, or (iii) sparkle; and user adjustment of the effect adjustment tool through the graphical user interface adjusts a corresponding effect displayed by the selected color tile.

In a sixth aspect, in the computer-implemented method as recited in any of the preceding aspects one through five, adjustment of one or more of the sub-component options causes the computer system to generate expected colorimetric values by interpolating previously measured colorimetric values in similar colors.

In a seventh aspect, the computer-implemented method as recited in any of the preceding aspects one through six can further include displaying a formulation of the color corresponding to the selected color tile, wherein the formulation comprises a plurality of sub-component ingredients and corresponding amounts; and receiving one or more user inputs that adjust the formulation by adjusting one or more of a (i) type of sub-component; or (ii) amount of sub-component, thereby producing an adjusted formulation. In an eighth aspect, the computer-implemented method as recited in any of the preceding aspects one through seven can further include determining expected colorimetric values of the adjusted formulation by comparison with one or more related formulations; and displaying the selected color tile with image data derived from the expected colorimetric values.

In a ninth aspect, the computer-implemented method as recited in any of the preceding aspects one through seven can include determining expected colorimetric values of the adjusted formulation by comparison with one or more related formulations identified in the database; and displaying one or more closest match colors retrieved from the database, the one or more closest match colors each having colorimetric values that are closest matched to the determined colorimetric values. In a tenth aspect, the computer-implemented method as recited in any of the preceding aspects one through nine can further include displaying a popularity rating beside each color tile of the digital displayed color tiles. In an eleventh aspect, the computer-implemented method as recited in any of the preceding aspects one through ten can further include displaying a geographic region corresponding to the popularity rating.

In a twelfth aspect, another or additional configuration of a computer-implemented method for displaying a color and formula adjustment of an asset to be repainted, can include providing through a display a graphical user interface comprising one or more selectable elements for retrieving spectrophotometer data measured from a target asset to be repainted; receiving spectrophotometer data of an asset to be repainted from an end user of the graphical user interface, the spectrophotometer data of a target asset retrieved from a hand-held spectrophotometric device connected to the digital display; retrieving from a database a plurality of closest match colors corresponding to the spectrophotometer data; displaying on the graphical user interface a plurality of selectable color tiles corresponding to the retrieved closest match colors, and further displaying an image for one or more selectable sub-component options that, when adjusted by the end user, alters a formula for at least one of the selectable color tiles; upon selection of any of the one or more selectable sub-component options, retrieving from the database a plurality of alternate formulas that are closest matched to the selected sub-component option and the corresponding selectable color tile; displaying an image of the retrieved plurality of alternate formulas in the form of corresponding selectable alternate color tiles.

In a thirteenth aspect, the computer-implemented method as recited in the preceding aspect twelve can further include displaying the alternate formulation for each of the alternate color tiles, wherein each alternate formulation comprises a plurality of selectable sub-component ingredients and corresponding amounts; and receiving one or more user inputs that adjust a selected alternate formulation by adjusting one or more of a (i) type of sub-component; or (ii) amount of sub-component, thereby producing an adjusted alternate formulation.

In a fourteenth aspect, the computer-implemented method as recited in any of the preceding aspects twelve through thirteen can further include determining expected colorimetric values of the adjusted alternate formulation by comparison with one or more related formulations identified in the database; and displaying the selected color tile with image data derived from the determined colorimetric values.

In a fifteenth aspect, the computer-implemented method as recited in any of the preceding aspects twelve through fourteen can further include determining expected colorimetric values of the adjusted formulation by comparison with one or more related formulations identified in the database; and displaying one or more closest match colors retrieved from the database, the one or more closest match colors each having colorimetric values that are closest matched to the determined colorimetric values.

In a sixteenth aspect, the computer-implemented method as recited in any of the preceding aspects twelve through fifteen, the sub-component options further can include a slide tool corresponding to lightness of a tint in the color; and user adjustment of the tint through the graphical user interface further adjusts the adjusted image of the selectable color tile in the graphical user interface for tint amount.

In a seventeenth aspect, in the computer-implemented method as recited in any of the preceding aspects twelve through sixteen, the sub-component options further can include a slide tool corresponding to travel in the color; and user adjustment of the tint through the graphical user interface further adjusts the adjusted image of the selectable color tile in the graphical user interface for desired travel.

In an eighteenth aspect, the computer-implemented method as recited in any of the preceding aspects twelve through seventeen can further include displaying the image and the adjusted image in the graphical user interface as a 3D image of the corresponding color tile upon user selection. In a nineteenth aspect, the computer-implemented method as recited in any of the preceding aspects twelve through eighteen can further include displaying a popularity rating beside each color tile of the digital displayed color tiles. In a twentieth aspect, the computer-implemented method as recited in any of the preceding aspects twelve through nineteen can further include displaying a geographic region corresponding to the popularity rating.

In a nineteenth aspect, the computer-implemented method as recited in any of the preceding aspects one through eighteenth, the database comprises spectral, and colorimetric data for coatings and coating sub-component.

In a twentieth aspect, the computer-implemented method as recited in any of the preceding aspects one through nineteen, the closest match colors are determined by comparison the retrieved spectrophotometer data with spectral, and colorimetric data for coatings and coating sub-component.

In a twenty-first aspect, the computer-implemented method as recited in any of the preceding aspects one through twenty, the adjustment of the image, color tile and/or the formulation is done by interpolating colorimetric and spectral data for the closest match colors considering the selected sub-components.

In a twenty-second aspect, the computer-implemented method as recited in any of the preceding aspects one through twenty-one, the user interface comprises an image or a color tile having the initial color of the asset so that the user can compare the one or more closest match colors, the image, the adjusted image, and/or the adjusted formulation with the initial color of the asset.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

1-19. canceled.

20. A computer-implemented method for displaying a color and formula adjustment of an asset to be repainted, comprising:
providing via a digital display a graphical user interface comprising one or more selectable elements for retrieving spectrophotometer data measured from a target asset to be repainted;
receiving spectrophotometer data of the asset to be repainted from an end user of the graphical user interface, the spectrophotometer data retrieved from a hand-held spectrophotometric device connected to the digital display;
retrieving from a database a plurality of closest match colors corresponding to the spectrophotometer data;
displaying on the graphical user interface a plurality of selectable color tiles corresponding to the retrieved closest match colors, and further displaying an image for each of one or more selectable sub-component options that, when adjusted by the end user, alters a formula for at least one of the selectable color tiles;
upon selection of any of the one or more selectable sub-component options, displaying on the graphical user interface an adjusted image of the corresponding selectable color tile, wherein the adjusted image reflects an adjusted formulation of the corresponding retrieved closest match color displayed by the selected color tile;
upon receipt of user selection through the graphical user interface of the adjusted image, displaying on the graphical user interface the adjusted formulation for the selected color displayed by the selected color tile.

21. The computer-implemented method as recited in claim 20, wherein:
the sub-component options comprise a blend adjustment tool corresponding to adjustment of a ratio of a first sub-component relative to at least a second sub-component; and
user adjustment of the blend adjustment tool through the graphical user interface displays the selected color tile with a new color reflecting an adjusted ratio of the first and second sub-components.

22. The computer-implemented method as recited in claim 20, further comprising displaying the selected color tile as a 3D tile with one or more curves.

23. The computer-implemented method as recited in claim 20, wherein:
the sub-component options comprise a tint adjustment tool corresponding to any of: (i) chroma, (ii) hue, or (iii) lightness of a tint in the adjusted image; and
user adjustment of the tint adjustment tool through the graphical user interface adjusts display of the initial color corresponding to the selected color tile.

24. The computer-implemented method as recited in claim 20, wherein:
the sub-component options comprise an effect adjustment tool corresponding to any of: (i) travel, (ii) graininess, or (iii) sparkle; and
user adjustment of the effect adjustment tool through the graphical user interface adjusts a corresponding effect displayed by the selected color tile.

25. The computer-implemented method as recited in claim 20, further comprising:
displaying a formulation of the color corresponding to the selected color tile, wherein the formulation comprises a plurality of sub-component ingredients and corresponding amounts; and
receiving one or more user inputs that adjust the formulation by adjusting one or more of a (i) type of sub-component; or (ii) amount of sub-component, thereby producing an adjusted formulation.

26. The computer-implemented method as recited in claim 25, further comprising:
determining expected colorimetric values of the adjusted formulation by comparison with one or more related formulations; and
displaying the selected color tile with image data derived from the determined colorimetric values.

27. The computer-implemented method as recited in claim 25, further comprising:
determining expected colorimetric values of the adjusted formulation by comparison with one or more related formulations identified in the database; and
displaying one or more closest match colors retrieved from the database, the one or more closest match colors each having colorimetric values that are closest matched to the expected colorimetric values.

28. The computer-implemented method as recited in claim 20, further comprising:
displaying a popularity rating beside each color tile of the digital displayed color tiles.

29. The computer-implemented method as recited in claim 28, further comprising:
displaying a geographic region corresponding to the popularity rating.

30. A computer-implemented method for displaying a color and formula adjustment of an asset to be repainted, comprising:
providing through a display a graphical user interface comprising one or more selectable elements for retrieving spectrophotometer data measured from a target asset to be repainted;
receiving spectrophotometer data of the asset to be repainted from an end user of the graphical user interface, the spectrophotometer data of a target asset retrieved from a hand-held spectrophotometric device connected to the digital display;
retrieving from a database a plurality of closest match colors corresponding to the spectrophotometer data;
displaying on the graphical user interface a plurality of selectable color tiles corresponding to the retrieved closest match colors, and further displaying an image for one or more selectable sub-component options that, when adjusted by the end user, alters a formula for at least one of the selectable color tiles;
upon selection of any of the one or more selectable sub-component options, retrieving from the database a plurality of alternate formulas that are closest matched to the selected sub-component option and the corresponding selectable color tile;
displaying an image of the retrieved plurality of alternate formulas in the form of corresponding selectable alternate color tiles.

31. The computer-implemented method as recited in claim 30, further comprising:
displaying the alternate formulation for each of the alternate color tiles, wherein each alternate formulation comprises a plurality of selectable sub-component ingredients and corresponding amounts; and
receiving one or more user inputs that adjust a selected alternate formulation by adjusting one or more of a (i) type of sub-component; or (ii) amount of sub-component, thereby producing an adjusted alternate formulation.

32. The computer-implemented method as recited in claim 31, further comprising:
determining expected colorimetric values of the adjusted alternate formulation by comparison with one or more related formulations identified in the database; and
displaying the selected color tile with image data derived from the determined colorimetric values.

33. The computer-implemented method as recited in claim 31, further comprising:
determining expected colorimetric values of the adjusted formulation by comparison with one or more related formulations identified in the database; and
displaying one or more closest match colors retrieved from the database, the one or more closest match colors each having colorimetric values that are closest matched to the determined colorimetric values.

34. The computer-implemented method as recited in claim 30, wherein:
the sub-component options further comprise a slide tool corresponding to lightness of a tint in the color; and
user adjustment of the tint through the graphical user interface further adjusts the adjusted image of the selectable color tile in the graphical user interface for tint amount.

35. The computer-implemented method as recited in claim 30, wherein:
the sub-component options further comprise a slide tool corresponding to travel in the color; and
user adjustment of the tint through the graphical user interface further adjusts the adjusted image of the selectable color tile in the graphical user interface for desired travel.

36. The computer-implemented method as recited in claim 30, further comprising:
displaying the image and the adjusted image in the graphical user interface as a 3D image of the corresponding color tile upon user selection.

37. The computer-implemented method as recited in claim 30, further comprising:
displaying a popularity rating beside each color tile of the digital displayed color tiles.

38. The computer-implemented method as recited in claim 37, further comprising:
displaying a geographic region corresponding to the popularity rating.
